(19) United States
(12) Patent Application Publication
(10) Pub. No.: US 2010/0072276 A1
(43) Pub. Date: Mar. 25, 2010

(54) METHOD AND SYSTEM FOR REWRITING CARD INFORMATION

(75) Inventor: Masaharu Minowa, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/561,853

(22) Filed: Sep. 17, 2009

Related U.S. Application Data
(63) Continuation of application No. PCT/JP2007/055706, filed on Mar. 20, 2007.

(51) Int. Cl. G06K 5/00

(52) U.S. Cl. 235/382; 235/380

(57) ABSTRACT

A system for rewriting card information includes: a personal information acquiring unit that acquires personal identification information for identifying an individual; a card layout information acquiring unit that acquires card layout information indicating a format of a card which records availability information indicating availability of facilities within an area corresponding to the personal information acquiring unit; and a card information rewriting unit that rewrites a format of availability information recorded in a card of an individual identified by the personal identification information acquired by the personal information acquiring unit into the format of the availability information indicating availability of facilities within the area corresponding to the personal information acquiring unit, based on the card layout information acquired by the card layout information acquiring unit.

### CROSS-REFERENCE TO RELATED APPLICATION(S)

This application is a continuation of PCT international application Ser. No. PCT/JP2007/055706 filed on Mar. 20, 2007 which designates the United States, the entire contents of which are incorporated herein by reference.

### FIELD

The embodiments discussed herein are directed to an apparatus and method for rewriting, recording, and managing information recorded in a card for personal authentication, and computer program therefor.

### BACKGROUND

Recently, various corporations, organizations, and the like use a card system using a card for personal authentication use (for example, an integrated circuit (IC) card) for managing entrance into and exit from a premise and use of facilities, to ensure security. In the card system, personal authentication is performed by reading out authentication information recorded in a card owned by an employee, for example, by a reader/writer installed at an entrance of a premise or a facility and the like, and checking the read-out authentication information against previously registered employee information.

Some big corporations have a plurality of business institutions at various locations. Such big corporations generally keep and manage information about their employees at each business institution, and the card system of each business institution registers only the information of employees working at the business institution. In this case, for example, when an employee visits another business institution on a business trip and the like, personal authentication cannot be performed using a card of the business visitor at a business institution of the business trip destination because employee information of the employee is not registered in the card system.

Usually, in this case, personal authentication is performed by a receptionist checking an employee identification (ID) card of the business visitor or making the business visitor fill out a predetermined form with his/her name, a business institution to which he/she belongs, and the like, at a front desk or the like installed near the entrance of a premise or a facility. Because this procedure is performed almost entirely by manpower, it takes long time especially when many visitors come at a same time period.

Japanese Laid-open Patent Publication No. 2002-73919, for example, discloses a business visitor confirmation method in which when an employee visits another business institution on a business trip, information about the employee is transmitted in advance to the card system of a business institution of the business trip destination, thereby making it possible for the employee to enter the premise without being kept waiting when actually entering the business institution of the business trip destination.

However, when each business institution creates cards and starts operation with the cards separately, or when a plurality of corporations are integrated into one, for example, recording system and configuration of recorded items of the information recorded in the card may be different for each business institution. In this case, the card system cannot perform personal authentication correctly because items cannot be collated, or different items are collated when checking information read out from the card information against employee information registered in the system.

### SUMMARY

According to an aspect of the invention, a system for rewriting card information includes: a personal information acquiring unit that acquires personal identification information for identifying an individual; an area-format information acquiring unit that acquires information on a recording format of availability information indicating availability of facilities within an area corresponding to the personal information acquiring unit; a card information rewriting unit that rewrites a recording format of availability information in a storage unit of a card, the availability information indicating availability for a user of the card, of facilities within a predetermined area, to the recording format of the availability information indicating the availability of facilities within the area corresponding to the personal information acquiring unit; a card layout information acquiring unit that acquires card layout information which is recording format information to be used for recording availability information in the storage unit of the card that records the availability information indicating the availability of facilities within the area corresponding to the personal information acquiring unit; and a card information rewriting unit that rewrites, based on the card layout information acquired by the card layout information acquiring unit, a recording format of availability information stored in a storage unit of a card which is used in the area corresponding to the personal identification acquiring unit by the individual identified by the personal identification information, the availability information stored in the storage unit indicating availability of facilities within the area corresponding to the personal information acquiring unit for the individual.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic for explaining a concept of a card system according to a first embodiment;

FIG. 2 is a functional block diagram of the configuration of the card system according to the first embodiment;

FIG. 3 is a table of an example of employee information;

FIG. 4 is a table of an example of card layout information;

FIG. 5 is a flowchart of the processing procedure of the card system according to the first embodiment;

FIG. 6 is a schematic for explaining a concept of a card system according to a second embodiment;

FIG. 7 is a functional block diagram of the configuration of the card system according to the second embodiment;

FIG. 8 is a flowchart of the processing procedure of the card system according to the second embodiment;

FIG. 9 is a flowchart of the processing procedure of a card system when format information of an IC card is written back to format information of a business institution to which an employee belongs at the time of exit;

FIG. 10 is a table of an example of employee information in which money amount information is retained;

FIG. 11 is a table of an example of card layout information in which money amount information is retained;

FIG. 12 is a flowchart of the processing procedure of a card system when money amount information is included in format information stored in an IC card;

FIG. 13 is a functional block diagram of the configuration of an IC chip that executes a card information rewriting program according to the present embodiment; and

FIG. 14 is a functional block diagram of the configuration of a computer that executes a card information rewriting program according to the present embodiment.

### DESCRIPTION OF EMBODIMENTS

In the following, embodiments of a card information rewriting apparatus, a card information rewrite method, a card information rewriting program, a card information recording apparatus, and a card information managing apparatus are explained in detail based on the figures. In the present embodiments, the present invention is applied to a card system using an IC card.

### First Embodiment

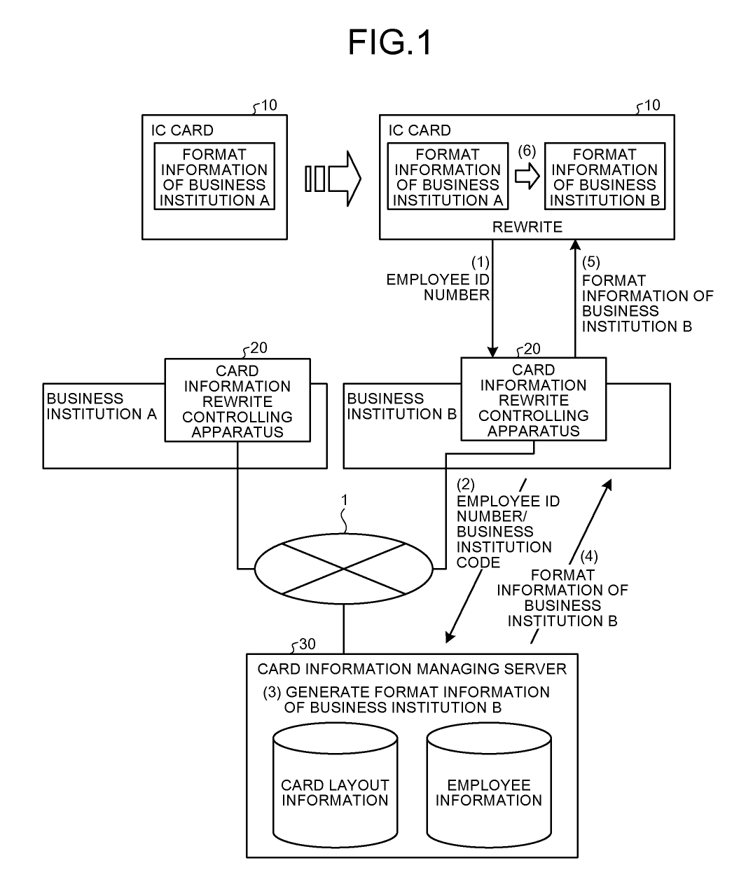

A concept of a card system according to the first embodiment is explained. FIG. 1 is a schematic for explaining a concept of the card system according to the first embodiment. As depicted in FIG. 1, the card system includes an IC card 10 for personal authentication use distributed for each employee, a card information rewrite controlling apparatus 20 including a reader/writer that reads and writes information from and in the IC card 10, and a card information managing server 30 that manages various pieces of information about an IC card.

The IC card 10 stores therein an employee ID number of an employee who is an owner of the IC card 10, and format information in which availability of facilities within a given business institution for the employee is set.

The card information rewrite controlling apparatus 20 is installed at each business institution, and is connected communicatably to the card information managing server 30 via a network 1. For example, in FIG. 1, the card information rewrite controlling apparatus 20 is installed at each of business institutions A and B.

The card information managing server 30 stores therein employee information including availability information indicating availability of facilities within each business institution for each employee, and stores therein, for each business institution, card layout information that is format information of a card in which the availability information is recorded.

In the card system according to the first embodiment with this configuration, the card information rewrite controlling apparatus 20 installed at each business institution acquires an employee ID number from the IC card 10 of an employee visiting on a business trip and the like. The card information managing server 30 acquires employee information of the employee based on the employee ID number acquired from the card information rewrite controlling apparatus 20, and card layout information of the business institution where the card information rewrite controlling apparatus 20 is installed, and generates format information in which availability of facilities within the business institution for the employee is set based on the acquired employee information and the acquired card layout information. The IC card 10 acquires the format information generated by the card information managing server 30, and rewrites the format information having been stored therein until then using the format information acquired from the card information managing server 30.

In the following, these features are explained specifically using FIG. 1. It is assumed here that an employee X belonging to the business institution A visits the business institution B on a business trip, and an employee ID number of the employee X, and format information in which availability of facilities within the business institution A for the employee X is set are recorded in the IC card 10 owned by the employee X in advance.

Upon arrival at the business institution B, the employee X brings the IC card 10 that he/she owns closer to a reader/writer of the card information rewrite controlling apparatus 20 installed at the business institution B as depicted in FIG. 1. The card information rewrite controlling apparatus 20 acquires the employee ID number transmitted from the IC card 10 via the reader/writer (see (1) in FIG. 1), and transmits the acquired employee ID number, and a business institution code of the business institution B to the card information managing server 30 (see (2) in FIG. 1).

Upon receiving the employee ID number and the business institution code, the card information managing server 30 reads out employee information of the employee X from the stored employee information based on the received employee ID number, reads out card layout information of the business institution B from the stored card layout information, and generates format information in which availability of facilities within the business institution B for the employee X is set based on the read-out employee information, and the read-out card layout information (see (3) in FIG. 1). The card information managing server 30 transmits the generated format information to the card information rewrite controlling apparatus 20 (see (4) in FIG. 1).

Upon receiving the format information generated by the card information managing server 30, the card information rewrite controlling apparatus 20 transmits the format information to the IC card 10 of the employee X (see (5) in FIG. 1).

Upon receiving the format information, the IC card 10 rewrites format information about the business institution A recorded therein until then using the received format information (see (6) in FIG. 1). Thereby, personal authentication of the employee X can be performed using the IC card 10 at the business institution B.

As can be seen, in the card system according to the first embodiment, when an employee visits another business institution on a business trip, format information recorded in the IC card 10 owned by the employee is rewritten to format information corresponding to the business institution of the business trip destination automatically by a card system of the business trip destination. Accordingly, personal authentication is possible at each business institution even when card layout information of the IC card for personal authentication use is different for each business institution.

Although, for convenience of explanation, only the two card information rewrite controlling apparatuses 20 installed at the business institutions A and B are illustrated, the card system is configured by a number of card information rewriting apparatuses installed at business institutions of various locations.

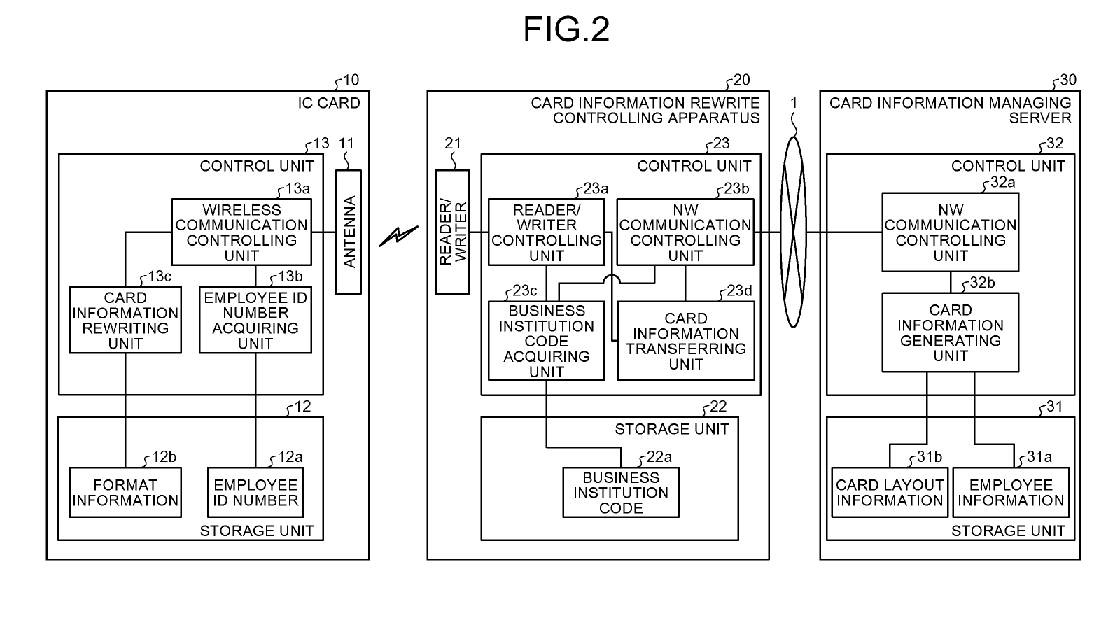

The configuration of the card system according to the first embodiment is explained. FIG. 2 is a functional block diagram of the configuration of the card system according to the first embodiment. As depicted in FIG. 2, the card system includes the IC card 10, the card information rewrite controlling apparatus 20, and the card information managing server 30 connected to the card information rewrite controlling apparatus 20 via the network 1.

The IC card 10 incorporates an IC chip in which various pieces of information for personal authentication use are recorded, and includes an antenna 11 for wireless communication with a reader/writer, a storage unit 12, and a control unit 13.

The storage unit 12 stores therein various pieces of information and computer programs, and stores therein an employee ID number 12a, and format information 12b as those related to the present invention.

The employee ID number 12a is for identifying an employee who is the owner of the IC card 10.

In the format information 12b, availability of facilities within a given business institution for the employee who is the owner of the IC card 10 is set. For example, in the format information 12b, an authentication code for logging into a terminal device such as a personal computer, an authentication code for opening a door to a room within a given business institution, and the like are set based on card layout information determined at the business institution.

The control unit 13 performs various types of processing by executing various computer programs stored in the storage unit 12, and includes a wireless communication controlling unit 13a, an employee ID number acquiring unit 13b, and a card information rewriting unit 13c as those related to the present invention.

The wireless communication controlling unit 13a controls transmission/reception of information exchanged with the card information rewrite controlling apparatus 20 via a reader/writer. For example, the wireless communication controlling unit 13a transmits an employee ID number to the card information rewrite controlling apparatus 20, and receives format information corresponding to a business institution from the card information rewrite controlling apparatus 20.

The employee ID number acquiring unit 13b acquires the employee ID number 12a stored in the storage unit 12. Specifically, upon receiving a command to read out an employee ID number from the card information rewrite controlling apparatus 20 via the wireless communication controlling unit 13a, the employee ID number acquiring unit 13b reads out the employee ID number 12a from the storage unit 12, and transmits the read-out employee ID number 12a to the card information rewrite controlling apparatus 20 via the wireless communication controlling unit 13a.

The card information rewriting unit 13c rewrites the format information 12b stored in the storage unit 12. Specifically, upon receiving the format information from the card information rewrite controlling apparatus 20 via the wireless communication controlling unit 13a, the card information rewriting unit 13c rewrites the format information 12b stored in the storage unit 12 using the received format information.

In the format information transmitted from the card information rewrite controlling apparatus 20, availability of facilities within a business institution where the card information rewrite controlling apparatus 20 is installed is set for the owner of the IC card 10.

The card information rewrite controlling apparatus 20 rewrites data recorded in the IC card 10, and includes a reader/writer 21, a storage unit 22, and a control unit 23.

The reader/writer 21 detects the IC card 10 within a predetermined range, and accesses data recorded in the detected IC card 10 by wireless communication. For example, the reader/writer 21 transmits to the IC card 10 a command to read out data recorded in the IC card 10, and a command to write data in the IC card 10, and receives data read out from the IC card 10, information indicating a result of reading/writing, and the like from the IC card 10.

The storage unit 22 stores therein various pieces of information and computer programs, and stores therein a business institution code 22a as those related to the present invention. The business institution code 22a is an identifier that identifies a business institution where the card information rewrite controlling apparatus 20 is installed.

The control unit 23 controls overall operations of the card information rewrite controlling apparatus 20, and includes a reader/writer controlling unit 23a, a network (NW) communication controlling unit 23b, a business institution code acquiring unit 23c, and a card information transferring unit 23d as those related to the present invention.

The reader/writer controlling unit 23a reads out data from the IC card 10, and writes data in the IC card 10 by controlling a reader/writer.

Specifically, when the reader/writer 21 detects the IC card 10, the reader/writer controlling unit 23a instructs the reader/writer 21 to transmit a command to read out an employee ID number recorded in the IC card 10. When the reader/writer receives the employee ID number from the IC card 10, the reader/writer controlling unit 23a acquires the employee ID number, and passes the employee ID number to the business institution code acquiring unit 23c.

When the format information corresponding to a business institution where the card information rewrite controlling apparatus 20 is installed is passed over from the card information transferring unit 23d described below, the reader/writer controlling unit 23a transmits to the IC card 10 a command to write the format information in the IC card 10.

The NW communication controlling unit 23b controls transmission/reception of information exchanged with the card information managing server 30 via the network 1. For example, the NW communication controlling unit 23b transmits a business institution code and an employee ID number passed over from the business institution code acquiring unit 23c described below to the card information managing server 30, and receives format information corresponding to a business institution where the card information rewrite controlling apparatus 20 is installed from the card information managing server 30.

The business institution code acquiring unit 23c acquires a business institution code of a business institution where the card information rewrite controlling apparatus 20 is installed, and transmits to the card information managing server 30 the business institution code together with the employee ID number. Specifically, when the employee ID number is passed over from the reader/writer controlling unit 23a, the business institution code acquiring unit 23c reads out the business institution code 22a stored in the storage unit 22, and transmits the read-out business institution code 22a and the employee ID number to the card information managing server 30 via the NW communication controlling unit 23b.

The card information transferring unit 23d transfers format information transmitted from the card information managing server 30 to the IC card 10. Specifically, when the NW communication controlling unit 23b receives format information corresponding to a businesses institution where the card information rewrite controlling apparatus 20 is installed, the card information transferring unit 23d acquires the format information, and passes the format information over to the reader/writer controlling unit 23a.

The card information managing server 30 manages various pieces of information about the IC card 10, and includes a storage unit 31, and a control unit 32.

The storage unit 31 stores therein various pieces of information and computer programs, and stores therein employee information 31a, and card layout information 31b as those related to the present invention.

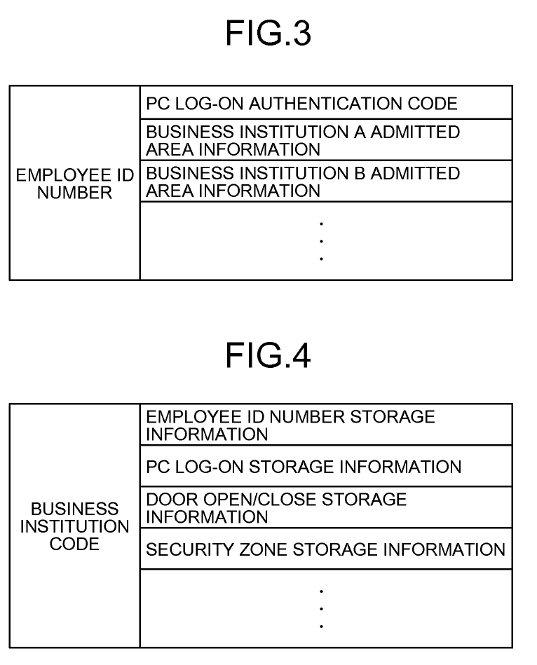

In the employee information 31a, employee information including availability information indicating availability of facilities within each business institution is set for each employee. FIG. 3 is a table of an example of the employee information 31a. As depicted in FIG. 3, in the employee information 31a, a “personal computer (PC) log-on authentication code” that is an authentication code for logging into a terminal device such as a personal computer, “business institution A admitted area information” and “business institution B admitted area information” that are authentication codes for opening doors to rooms within a given business institution, and the like are set in association with an employee ID number. Although employee information of only one employee is depicted in FIG. 3, the employee information 31a includes employee information of a plurality of employees.

In the card layout information 31b, card layout information that is format information of a card in which availability information is recorded is set for each business institution. FIG. 4 is a table of an example of the card layout information 31b. As depicted in FIG. 4, in the card layout information 31b, “employee ID number storage information” in which an employee ID number is recorded, “PC log-on storage information” in which a PC log-on authentication code is recorded, “door open/close storage information” in which authentication codes for opening doors to rooms within a business institution are recorded, “security zone storage information”, and the like are set. Although format information of only one business institution is depicted in FIG. 4, the card layout information 31b includes format information of a plurality of business institutions.

Recording systems and items of format information that configures the card layout information 31b may be different for each business institution. Format information in which availability of facilities for a specific employee at a specific business institution is set can be generated by using the format information, and availability information included in the employee information 31a described above.

Because the format information includes authentication information for logging into a terminal device that can be used in a business institution, an employee who visits another business institution on a business trip can use a terminal device installed at the business institution.

The control unit 32 controls overall operations of the card information managing server 30, and includes an NW communication controlling unit 32a, and a card information generating unit 32b as those related to the present invention.

The NW communication controlling unit 32a controls transmission/reception of information exchanged with the card information rewrite controlling apparatus 20 via the network 1. For example, the NW communication controlling unit 32a transmits format information passed over from the card information generating unit 32b described below to the card information rewrite controlling apparatus 20, and receives a business institution code, and an employee ID number from the card information rewrite controlling apparatus 20.

The card information generating unit 32b generates format information corresponding to an employee, and a business institution. Specifically, when the NW communication controlling unit 32a receives a business institution code and an employee ID number transmitted from the card information rewrite controlling apparatus 20, the card information generating unit 32b acquires the business institution code, and the employee ID number.

The card information generating unit 32b reads out employee information corresponding to the acquired employee ID number from the employee information 31a stored in the storage unit 31, reads out card layout information corresponding to the acquired business institution code from the card layout information 31b stored in the storage unit 31, and generates format information based on the read-out availability information, and the read-out card layout information.

In the format information generated by the card information generating unit 32b, availability of facilities within a business institution of a visiting destination for an employee who is the owner of the IC card 10 is set.

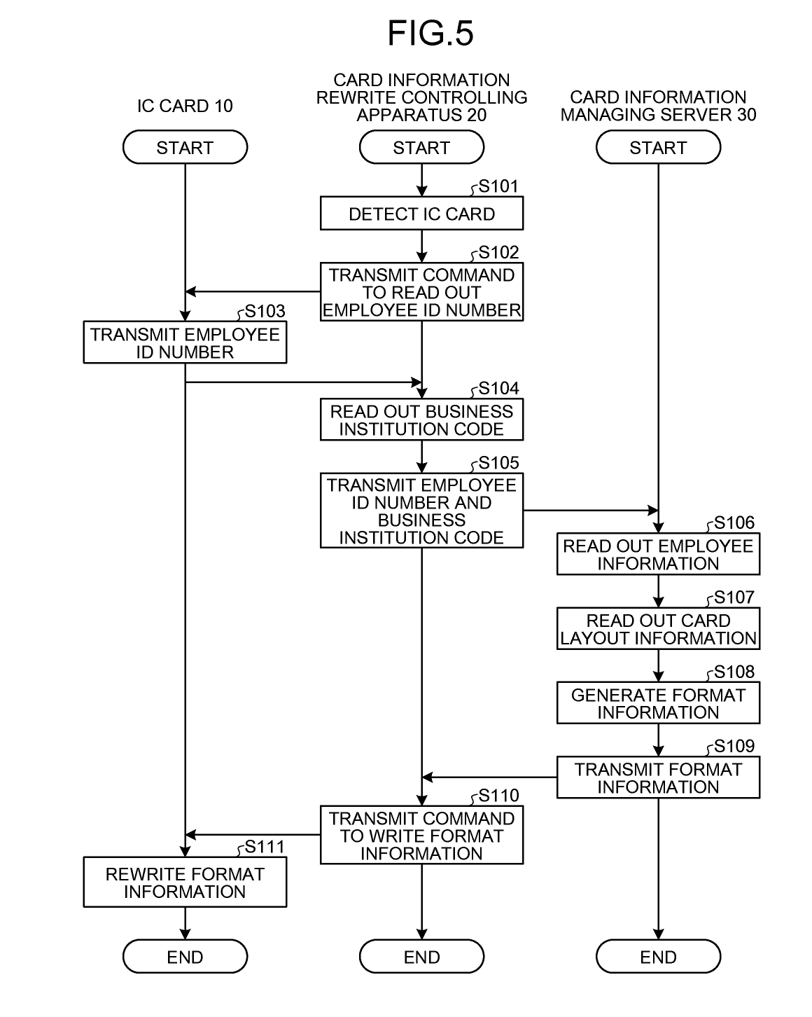

In the following, the processing procedure of the card system according to the first embodiment is explained. FIG. 5 is a flowchart of the processing procedure of the card system according to the first embodiment. As depicted in FIG. 5, in the card system, for example, when an employee visits another business institution on a business trip, and the card information rewrite controlling apparatus 20 installed at the business institution of the business trip destination detects the IC card 10 of the business visitor (Step S101), the card information rewrite controlling apparatus 20 transmits a command to read out an employee ID number to the IC card 10 (Step S102).

Upon receiving the read-out command, the IC card 10 transmits the employee ID number 12a to the card information rewrite controlling apparatus 20 (Step S103).

Upon receiving the employee ID number 12a transmitted from the IC card 10, the card information rewrite controlling apparatus 20 reads out the business institution code 22a from the storage unit 22 (Step S104), and transmits to the card information managing server 30 the read-out business institution code 22a together with the employee ID number 12a (Step S105).

Upon receiving the employee ID number 12a, and the business institution code 22a, the card information managing server 30 reads out employee information corresponding to the received employee ID number 12a from the employee information 31a (Step S106), reads out card layout information corresponding to the received business institution code 22a from the card layout information 31b (Step S107), and generates format information (Step S108). The card information managing server 30 transmits the generated format information to the card information rewrite controlling apparatus 20 (Step S109).

Upon receiving the format information from the card information managing server 30, the card information rewrite controlling apparatus 20 transmits a command to write the format information to the IC card 10 (Step S110).

Upon receiving the write command, the IC card 10 rewrites the format information 12b stored in the storage unit 12 using the format information transmitted together with the write command (Step S111).

As can be seen, in the first embodiment, personal authentication is possible at each business institution even when card layout information of the IC card for personal authentication use is different for each business institution because: the card information rewrite controlling apparatus 20 acquires the employee ID number 12a from the IC card 10 of an employee visiting on a business trip or the like; the card information managing server 30 acquires employee information of the employee, and card layout information of a business institution where the card information rewrite controlling apparatus 20 is installed based on the employee ID number 12a acquired from the card information rewrite controlling apparatus 20, and generates format information in which availability of facilities within the business institution is set for the employee based on the acquired employee information and the acquired card layout information; and the IC card 10 acquires the format information generated by the card information managing server 30, and rewrites the format information 12b having been stored therein until then using the format information acquired from the card information managing server 30.

### Second Embodiment

Recently, an IC card equipped with a central processing unit (CPU) on an IC chip has become a main stream, and by executing various computer programs using the CPU, various types of processing can be performed.

In the second embodiment, the IC card 10 generates format information, which is in the first embodiment generated by the card information managing server 30.

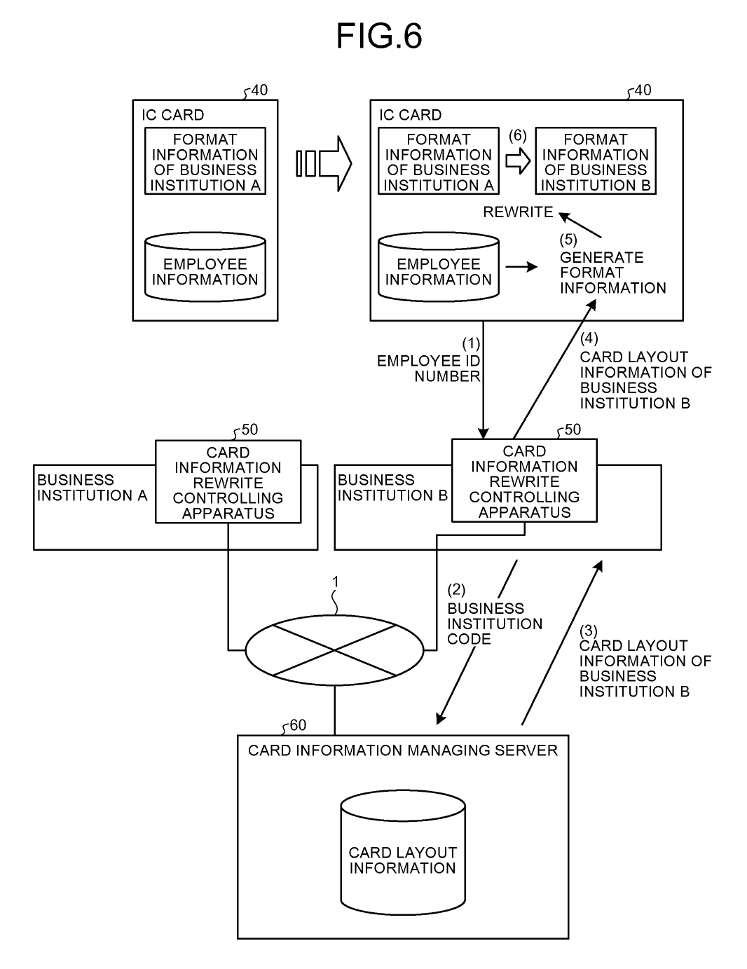

A concept of a card system according to the second embodiment is explained. FIG. 6 is a schematic for explaining the concept of the card system according to the second embodiment. As depicted in FIG. 6, the card system includes an IC card 40 distributed for each employee for personal authentication use, a card information rewrite controlling apparatus 50 including a reader/writer that reads out information from the IC card 40, and a card information managing server 60 that manages various pieces of information about the IC card.

The IC card 40 stores therein employee information including an employee ID number of an employee who is the owner of the IC card 40, and availability information indicating availability of facilities within each business institution for the employee, and format information in which availability of facilities within a given business institution for the employee (for example, facilities within a business institution to which the employee belongs) is set.

The card information rewrite controlling apparatus 50 is installed at each business institution, and is connected communicatably to the card information managing server 60 via the network 1. For example, in FIG. 6, the card information rewrite controlling apparatus 50 is installed at each of the business institutions A and B.

The card information managing server 60 stores therein for each business institution card layout information that is format information of a card in which availability information is recorded.

In the card system according to the second embodiment with this configuration, the IC card 40 acquires an employee ID number of an employee who is the owner of the IC card 40 from a recording area in the card, and transmits the employee ID number to the card information rewrite controlling apparatus 50; the card information rewrite controlling apparatus 50 acquires card layout information of the business institution that the employee is visiting from the card information managing server 60; the IC card 40 acquires employee information from the storage area in the card, acquires card layout information from the card information rewrite controlling apparatus 50, generates format information in which availability of facilities within the business institution for the employee is set based on the acquired employee information and the acquired card layout information, and rewrites format information having been stored therein until then using the generated format information.

In the following, these features are explained specifically using FIG. 6. It is assumed here similarly to the first embodiment that the employee X belonging to the business institution A visits the business institution B on a business trip, and employee information including an employee ID number of the employee X, and availability information indicating availability of facilities within each business institution for the employee X, and format information in which availability of facilities within the business institution A for the employee X is set are stored in the IC card 40 owned by the employee X in advance.

Upon arrival at the business institution B, the employee X brings the IC card 40 that he/she owns closer to a reader/writer of the card information rewrite controlling apparatus 50 installed at the business institution B as depicted in FIG. 6. The IC card 40 acquires an employee ID number from the storage area in the card, and transmits the employee ID number to the card information rewrite controlling apparatus 50 (see (1) in FIG. 6). Upon receiving the employee information, the card information rewrite controlling apparatus 50 transmits a business institution code of the business institution B to the card information managing server 60 (see (2) in FIG. 6).

Upon receiving the business institution code, the card information managing server 60 reads out card layout information of the business institution B from the stored card layout information, and transmits the read-out card layout information to the card information rewrite controlling apparatus 50 (see (3) in FIG. 6).

Upon receiving the card layout information from the card information managing server 60, the card information rewrite controlling apparatus 50 transmits the card layout information to the IC card 40 of the employee X (see (4) in FIG. 6).

Upon receiving the card layout information, the IC card 40 generates format information in which availability of facilities within the business institution B for the employee X is set based on the received card layout information and the stored employee information (see (5) in FIG. 6), and rewrites format information about the business institution A recorded therein until then using the generated format information (see (6) in FIG. 6). Thereby, personal authentication of the employee X using the IC card 40 becomes possible at the business institution B.

As can be seen, in the card system according to the second embodiment, similarly to the first embodiment, personal authentication is possible at each business institution even when card layout information of the IC card 40 for personal authentication use is different for each business institution because when an employee visits another business institution on a business trip, format information recorded in the IC card 40 is automatically rewritten to format information corresponding to the business institution of the business trip destination by the card system of the business trip destination. Furthermore it becomes possible to prevent leakage of format information within the network 1 and realize higher security because format information recorded in the IC card 40 is not transmitted via the network 1.

Although, for convenience of explanation, similarly to the first embodiment, only the two card information rewrite controlling apparatuses 50 installed at the business institutions A and B are illustrated, the card system is configured by a number of card information rewriting apparatuses installed at business institutions of various locations.

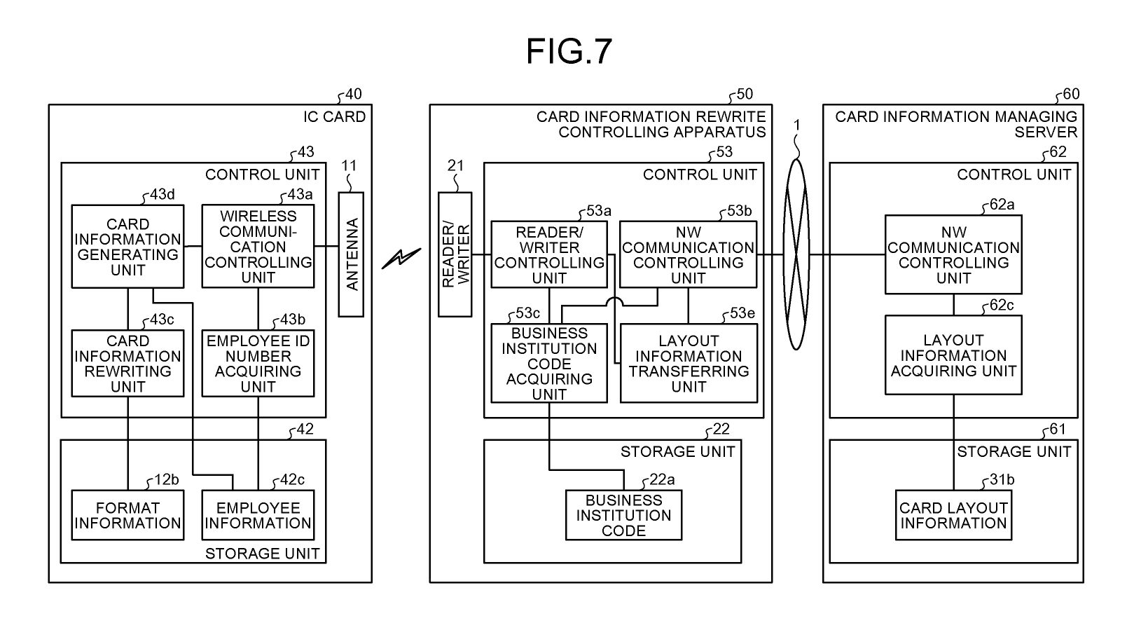

The configuration of the card system according to the second embodiment is explained. FIG. 7 is a functional block diagram of the configuration of the card system according to the second embodiment. As depicted in FIG. 7, the card system includes the IC card 40, the card information rewrite controlling apparatus 50, and the card information managing server 60 connected to the card information rewrite controlling apparatus 50 via the network 1. For convenience of explanation, functional units playing the roles similar to those of the units depicted in FIG. 2 are given the same symbols, and detailed explanation thereof is not repeated.

The IC card 40 incorporates an IC chip in which various pieces of information for personal authentication use are recorded, and includes the antenna 11 for wireless communication with a reader/writer, a storage unit 42, and a control unit 43.

The storage unit 42 stores therein various pieces of information and computer programs, and stores therein the format information 12b, and employee information 42c as those related to the present invention.

The employee information 42c includes an employee ID number of an employee who is the owner of the IC card 40, and availability information indicating availability of facilities within each business institution for the employee. For example, items similar to the employee information exemplified in FIG. 3 are set in the employee information 42c.

The control unit 43 performs various types of processing by executing various computer programs stored in the storage unit 42, and includes a wireless communication controlling unit 43a, an employee ID number acquiring unit 43b, a card information generating unit 43d, and a card information rewriting unit 43c as those related to the present invention.

The wireless communication controlling unit 43a controls transmission/reception of information exchanged with the card information rewrite controlling apparatus 50 via a reader/writer. For example, the wireless communication controlling unit 43a transmits an employee ID number to the card information rewrite controlling apparatus 50, and receives card layout information corresponding to a business institution from the card information rewrite controlling apparatus 50.

The employee ID number acquiring unit 43b acquires an employee ID number from the employee information 42c stored in the storage unit 42. Specifically, upon receiving a command to read out an employee ID number from the card information rewrite controlling apparatus 50 via the wireless communication controlling unit 43a, the employee ID number acquiring unit 43b reads out an employee ID number from the employee information 42c stored in the storage unit 42, and transmits the read-out employee TD number to the card information rewrite controlling apparatus 50 via the wireless communication controlling unit 43a.

The card information generating unit 43d generates format information corresponding to an employee, and a business institution. Specifically, when the wireless communication controlling unit 43a receives card layout information transmitted from the card information rewrite controlling apparatus 50, the card information generating unit 43d acquires the card layout information, reads out the employee information 42c stored in the storage unit 42, and generates formation information based on the read-out employee information 42c, and the acquired card layout information.

Because the card layout information transmitted from the card information rewrite controlling apparatus 50 corresponds to a business institution, in the format information generated by the card information generating unit 43d, availability of facilities within a business institution of a visiting destination for an employee who is the owner of the IC card 40 is set.

The card information rewriting unit 43c rewrites the format information 12b stored in the storage unit 42. Specifically, when format information is passed over from the card information generating unit 43d, the card information rewriting unit 43c rewrites the format information 12b stored in the storage unit 42 using the format information.

In the format information passed over from the card information generating unit 43d, availability of facilities in a business institution where the card information rewrite controlling apparatus 50 is installed for the owner of the IC card 40 is set.

The card information rewrite controlling apparatus 50 rewrites data recorded in the IC card 40, and includes the reader/writer 21, the storage unit 22, and a control unit 53.

The control unit 53 controls overall operations of the card information rewrite controlling apparatus 50, and includes a reader/writer controlling unit 53a, an NW communication controlling unit 53b, a business institution code acquiring unit 53c, and a layout information transferring unit 53e as those related to the present invention.

The reader/writer controlling unit 53a controls the reader/writer 21 to read out data from the IC card 40, and rewrites data in the IC card 40.

Specifically, when the reader/writer 21 detects the IC card 40, the reader/writer controlling unit 53a instructs the reader/writer 21 to transmit a command to read out an employee ID number recorded in the IC card 40. When the reader/writer 21 receives an employee ID number from the IC card 40, the reader/writer controlling unit 53a acquires the employee ID number, and passes the employee ID number to the business institution code acquiring unit 53c.

When the card layout information corresponding to a business institution where the card information rewrite controlling apparatus 50 is installed is passed over from the layout information transferring unit 53e described below, the reader/writer controlling unit 53a transmits the card layout information to the IC card 40.

The NW communication controlling unit 53b controls transmission/reception of information exchanged with the card information managing server 60 via the network 1. For example, the NW communication controlling unit 53b transmits a business institution code passed over from the business institution code acquiring unit 53c described below to the card information managing server 60, and receives card layout information corresponding to a business institution where the card information rewrite controlling apparatus 50 is installed from the card information managing server 60.

The business institution code acquiring unit 53c acquires a business institution code of a business institution where the card information rewrite controlling apparatus 50 is installed, and transmits the business institution code to the card information managing server 60. Specifically, when an employee ID number is passed over from the reader/writer controlling unit 53a, the business institution code acquiring unit 53c reads out the business institution code 22a stored in the storage unit 22, and transmits the read-out business institution code 22a to the card information managing server 60 via the NW communication controlling unit 53b.

The layout information transferring unit 53e transfers card layout information transmitted from the card information managing server 60 to the IC card 40. Specifically, when the NW communication controlling unit 53b receives card layout information corresponding to a business institution where the card information rewrite controlling apparatus 50 is installed, the layout information transferring unit 53e acquires the card layout information, and passes over the card layout information to the reader/writer controlling unit 53a.

The card information managing server 60 manages various pieces of information about the IC card 40, and includes a storage unit 61, and a control unit 62.

The storage unit 61 stores therein various pieces of information, and computer programs, and stores therein the card layout information 31b as those related to the present invention.

The control unit 62 controls overall operations of the card information managing server 60, and includes an NW communication controlling unit 62a, and a layout information acquiring unit 62c as those related to the present invention.

The NW communication controlling unit 62a controls transmission/reception of information exchanged with the card information rewrite controlling apparatus 50 via the network 1. For example, the NW communication controlling unit 62a transmits card layout information passed over from the layout information acquiring unit 62c described below to the card information rewrite controlling apparatus 50, and receives a business institution code from the card information rewrite controlling apparatus 50.

The layout information acquiring unit 62c acquires card layout information corresponding to a business institution. Specifically, when the NW communication controlling unit 62a receives a business institution code transmitted from the card information rewrite controlling apparatus 50, the layout information acquiring unit 62c acquires the business institution code, reads out card layout information corresponding to the acquired business institution code from the card layout information 31b stored in the storage unit 61, and passes the read-out card layout information to the NW communication controlling unit 62a.

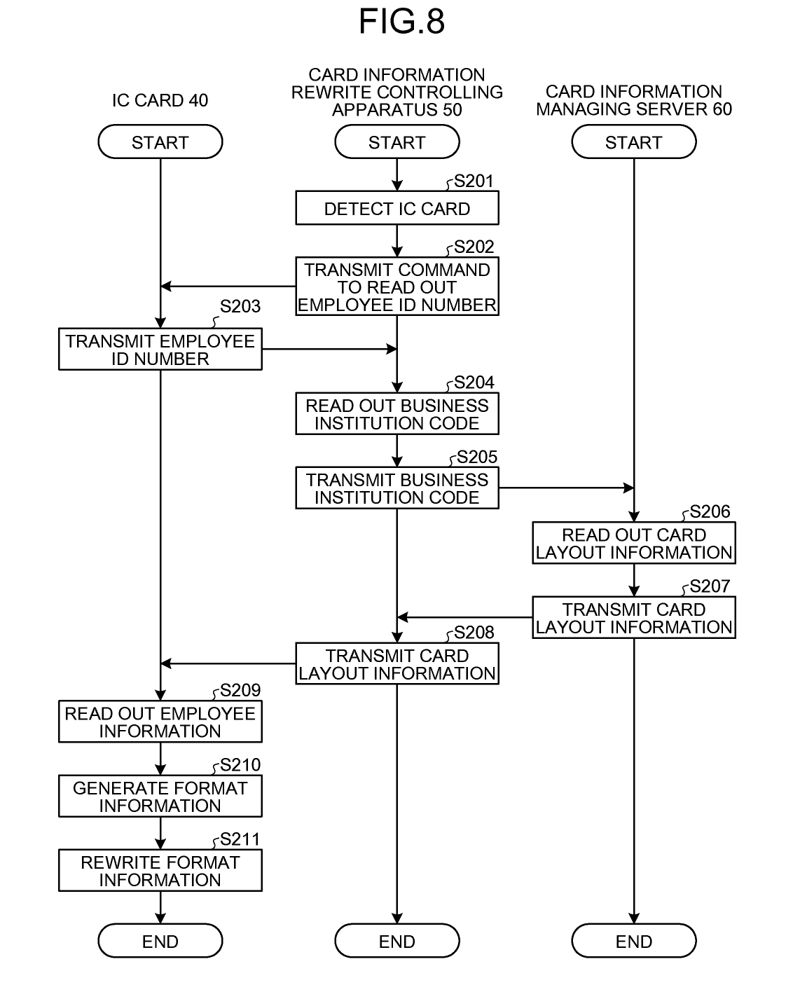

The processing procedure of the card system according to the second embodiment is explained. FIG. 8 is a flowchart of the processing procedure of the card system according to the second embodiment. As depicted in FIG. 8, in the card system, for example when an employee visits another business institution on a business trip, and the card information rewrite controlling apparatus 50 installed at the business institution of the business trip destination detects the IC card 40 of the business visitor (Step S201), the card information rewrite controlling apparatus 50 transmits to the IC card 40 a command to read out an employee ID number (Step S202).

Upon receiving the read-out command, the IC card 40 acquires an employee ID number from the employee information 42c stored in the storage unit 42, and transmits the employee ID number to the card information rewrite controlling apparatus 50 (Step S203).

Upon receiving the employee ID number transmitted from the IC card 40, the card information rewrite controlling apparatus 50 reads out the business institution code 22a from the storage unit 22 (Step S204), and transmits the read-out business institution code 22a to the card information managing server 60 (Step S205).

Upon receiving the business institution code 22a, the card information managing server 60 reads out card layout information corresponding to the received business institution code 22a from the card layout information 31b (Step S206), and transmits the read-out card layout information to the card information rewrite controlling apparatus 50 (Step S207).

Upon receiving the card layout information from the card information managing server 60, the card information rewrite controlling apparatus 50 transmits the card layout information to the IC card 40 (Step S208).

Upon receiving the card layout information, the IC card 40 reads out the employee information 42c from the storage unit 42 (Step S209), and generates format information based on the read-out employee information 42c, and the received card layout information (Step S210).

Then, the IC card 40 rewrites the format information 12b stored in the storage unit 42 using the generated format information (Step S211).

As described above, in the second embodiment, personal authentication is possible at each business institution even when card layout information of an IC card for personal authentication use is different for each business institution because: the IC card 40 acquires an employee ID number of an employee who is the owner of the IC card 40 from a recording area in the card, and transmits the employee ID number to the card information rewrite controlling apparatus 50; the card information rewrite controlling apparatus 50 acquires the card layout information of a business institution that the employee is visiting from the card information managing server 60; and the IC card 40 acquires the employee information 42c from the storage unit 42, acquires the card layout information from the card information rewrite controlling apparatus 50, generates format information in which availability of facilities within the business institution for the employee is set based on the acquired employee information 42c, and the acquired card layout information, and rewrites the format information 12b having been stored therein until then using the generated format information.

In the second embodiment, because format information recorded in the IC card 40 is not transmitted via a network, it is possible to prevent the format information from leaking within the network 1, and higher security can be realized.

Although preferred embodiments of the present invention have been explained so far, the present invention can be implemented in various different embodiments.

In the embodiments explained above, format information of the IC card is rewritten to format information corresponding to a business institution of a visiting destination when an employee enters the business institution of the visiting destination. For example, the format information of the IC card may be written back to the format information of a business institution to which the employee originally belongs when the employee exits the business institution of the visiting destination.

Specifically, a card information rewrite controlling apparatus is provided with an exit notifying unit (for example, an “exit” button) that notifies that an employee is exiting a business institution, and when the exit notifying unit notifies exit, format information of an IC card is rewritten based on card layout information corresponding to a business institution to which the employee who is exiting belongs.

To this end, an IC card distributed to an employee stores therein a business institution code of a business institution to which the employee belongs in advance.

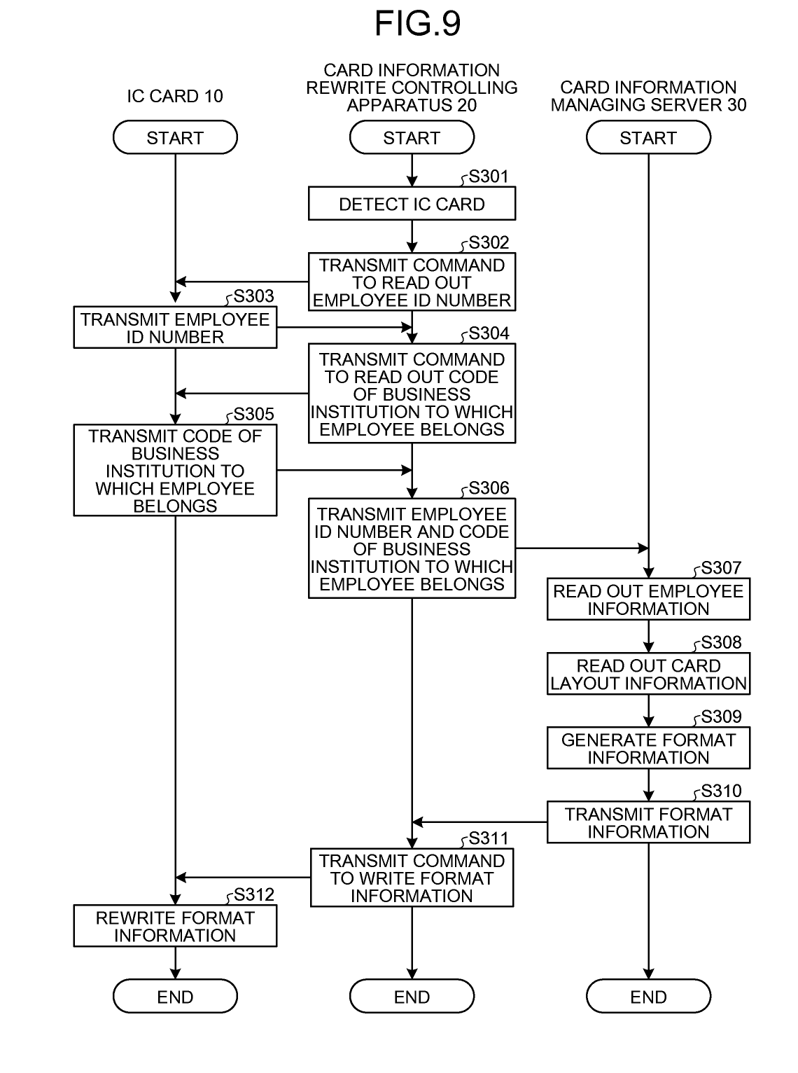

FIG. 9 is a flowchart of the processing procedure of a card system performed when format information of an IC card is written back, at the time of exit, to format information of a business institution to which an employee belongs. In this example, in the card system described in the first embodiment, format information of the IC card 10 is written back to format information of a business institution to which an employee belongs.

As depicted in FIG. 9, for example, when an employee notifies his/her exit using the exit notifying unit on exiting a business institution that he/she visits on a business trip, the card information rewrite controlling apparatus 20 installed at the business institution of the business trip destination detects the IC card 10 of the business visitor (Step S301), and the card information rewrite controlling apparatus 20 transmits to the IC card 10 a command to read out the employee ID number (Step S302).

Upon receiving the read-out command, the IC card 10 transmits the employee ID number 12a to the card information rewrite controlling apparatus 20 (Step S303).

Upon receiving the employee ID number 12a transmitted from the IC card 10, the card information rewrite controlling apparatus 20 further transmits to the IC card 10 a command to read out a code of a business institution to which the employee belongs (Step S304).

Upon receiving the read-out command, the IC card 10 transmits to the card information rewrite controlling apparatus 20 the code of the business institution to which the employee belongs that is stored therein in advance (Step S305).

Upon receiving the code of the business institution to which the employee belongs, the card information rewrite controlling apparatus 20 transmits to the card information managing server 30 the code of the business institution to which the employee belongs together with the already-received employee ID number 12a (Step S306).

Upon receiving the employee ID number 12a, and the code of the business institution to which the employee belongs, the card information managing server 30 reads out employee information corresponding to the received employee ID number 12a from the employee information 31a (Step S307), reads out card layout information corresponding to the received code of the business institution to which the employee belongs from the card layout information 31b (Step S308), and generates format information (Step S309). The card information managing server 30 transmits the generated format information to the card information rewrite controlling apparatus 20 (Step S310).

Upon receiving the format information from the card information managing server 30, the card information rewrite controlling apparatus 20 transmits a command to write the format information to the IC card 10 (Step S311).

Upon receiving the write command, the IC card 10 rewrites the format information 12b stored in the storage unit 12 using the format information transmitted together with the write command (Step S312).

As can be seen, because when an employee exits a business institution of a visiting destination, the card system writes back format information of an IC card to format information of a business institution to which the employee originally belongs, the employee can use facilities within the business institution to which he/she belongs without rewriting the format information stored in the card when the employee returns to the business institution to which he/she belongs, and the time required for entering the business institution to which he/she belongs can be shortened.

Although in the example, a code of a business institution to which an employee belongs is acquired from the IC card 10, an employee ID number, a code of a business institution to which an employee belongs, and card layout information may be stored in advance in relation with one another in the card information managing server 30, and the card layout information related to the code of a business institution to which an employee belongs may be acquired from the card information managing server 30 only by receiving the employee ID number from the IC card 10.

Although in the example, format information of an IC card is written back to format information of a business institution to which an employee belongs, the format information of the IC card may be erased instead of being written back to the format information of a business institution. Although in this case, when an employee enters a business institution, a work of writing format information corresponding to the business institution in the IC card is required, leakage of information recorded in the card can be prevented when the employee loses the IC card while he/she is traveling, or has his/her IC card stolen because format information is not stored in the IC card when the employee is outside. This is effective when important information such as secret information is included in the format information recorded in the IC card.

Although in the embodiments explained above, availability of facilities within a given business institution is set in format information stored in an IC card, money amount information such as accumulated amounts of dining hall usage fee, and company store usage fee may be retained. In this case, when the employee information 31a and the card layout information 31b are managed in the card information managing server 30, for example, as in the first embodiment, money amount information is set for each piece of the information.

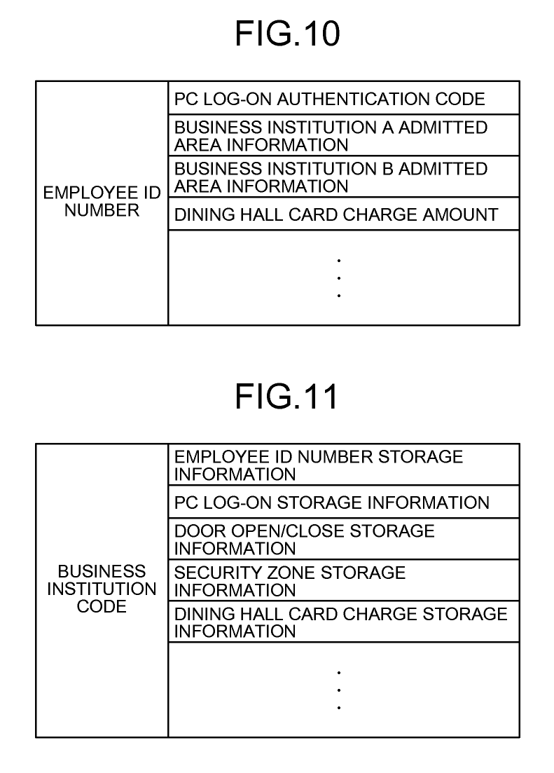

FIG. 10 is a table of an example of the employee information 31a in which money amount information is retained. In FIG. 10, a “dining card charge amount” for setting an accumulated amount of dining hall usage fee is additionally set in the employee information 31a depicted in FIG. 3.

FIG. 11 is a table of an example of the card layout information 31b in which money amount information is retained. In FIG. 11, a “dining hall card charge storage information” for accumulating a dining hall card charge amount is additionally set in the card layout information 31b depicted in FIG. 4 as in the employee information 31a described above.

When format information of an IC card is rewritten at a business institution of a visiting destination, money amount information retained in the IC card at the time point is first reflected in employee information of a card information managing server, and the card information managing server generates format information using the employee information in which the money amount information is reflected.

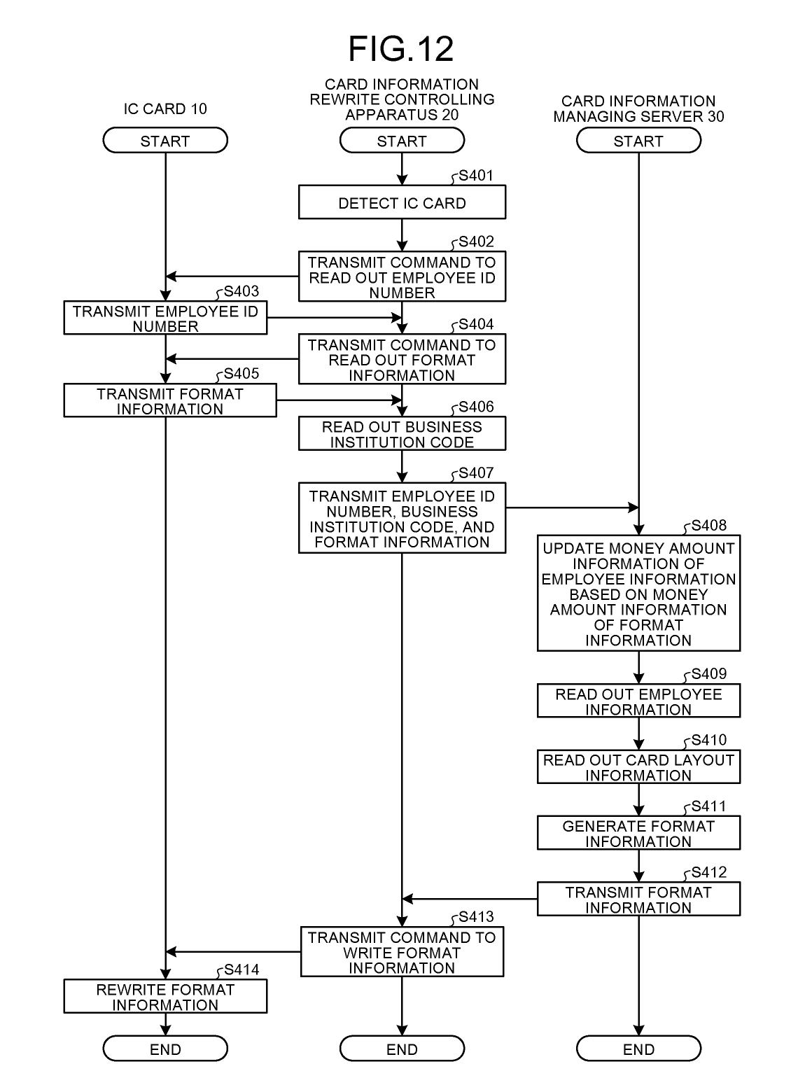

FIG. 12 is a flowchart of the processing procedure of a card system when money amount information is included in format information stored in an IC card. In this example, money amount information is included in format information of the IC card 10 in the card system described in the first embodiment.

As depicted in FIG. 12, when an employee visits another business institution on a business trip, for example, and the card information rewrite controlling apparatus 20 installed at the business institution of the business trip destination detects the IC card 10 of the business visitor (Step S401), the card information rewrite controlling apparatus 20 transmits to the IC card 10 a command to read out an employee ID number (Step S402) as in the first embodiment.

Upon receiving the read-out command, the IC card 10 transmits to the card information rewrite controlling apparatus 20 the employee ID number 12a (Step S403).

Upon receiving the employee ID number 12a transmitted from the IC card 10, the card information rewrite controlling apparatus 20 further transmits to the IC card 10 a command to read out the format information 12b (Step S404).

Upon receiving the read-out command, the IC card 10 reads out the format information 12b from the storage unit 12, and transmits the read-out format information 12b to the card information rewrite controlling apparatus 20 (Step S405).

Upon receiving the format information 12b transmitted from the IC card 10, the card information rewrite controlling apparatus 20 reads out the business institution code 22a from the storage unit 22 (Step S406), and transmits to the card information managing server 30 the read-out business institution code 22a together with the already-received employee ID number 12a and the format information 12b (Step S407).

Upon receiving the employee ID number 12a, the business institution code 22a, and the format information 12b, the card information managing server 30 first updates money amount information included in employee information corresponding to the received employee ID number 12a from among the employee information 31a stored in the storage unit 31 based on money amount information included in the received format information 12b (Step S408).

The card information managing server 30 reads out the updated employee information corresponding to the employee ID number 12a from the employee information 31a (Step S409), reads out card layout information corresponding to the received code of a business institution to which an employee belongs from the card layout information 31b (Step S410), and generates format information including money amount information (Step S411).

Thereafter, the processing similar to Steps S109 to S111 depicted in FIG. 5 is performed (Steps S412 to S414), and format information of the IC card 10 including money amount information is rewritten.

As can be seen, because even when format information of the IC card 10 includes money amount information, the format information is rewritten while an accumulated amount of the money amount information retained until then remains retained, an employee can use a dining hall and a company store of another business institution when he/she visits the business institution on a business trip.

Although an IC card is explained in the embodiment above, a computer program having a similar function can be obtained by realizing the configuration of the IC card by software. An IC chip that executes the computer program is explained. In the following, the computer program called a “card information rewriting program” is described.

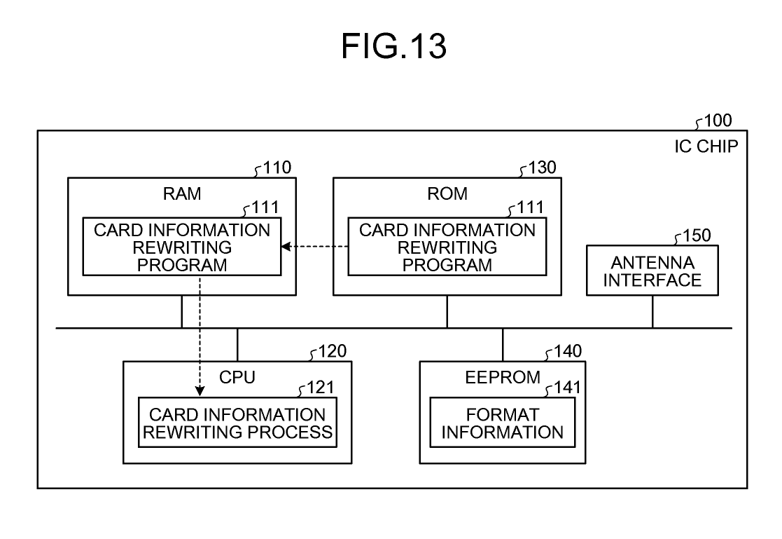

FIG. 13 is a functional block diagram of the configuration of the IC chip that executes a card information rewriting program according to the present embodiment. As depicted in FIG. 13, an IC chip 100 includes a random access memory (RAM) 110, a CPU 120, a read-only memory (ROM) 130, an electrically erasable programmable read-only memory (EEPROM) 140, and an antenna interface 150.

The RAM 110 stores therein a computer program, a result in the middle of executing the computer program, and the like, and the CPU 120 is a central processing unit that reads out and executes the computer program from the RAM 110.

The ROM 130 stores therein a computer program and data, and the EEPROM 140 stores therein data that is an object to be rewritten, such as format information 141, by a reader/writer.

The antenna interface 150 is an interface for connecting an antenna for wireless communication with a reader/writer.

Card information rewriting program 111 executed by the IC chip 100 is stored in advance in the ROM 130, read out by the RAM 110, and executed by the CPU 120 as a card information rewriting process 121.

Although in the embodiment explained above, a card information managing server is explained, a computer program having a similar function can be obtained by realizing the configuration of the card information managing server by software. A computer that executes the computer program is explained. The computer program called a “card information rewriting program” is described.

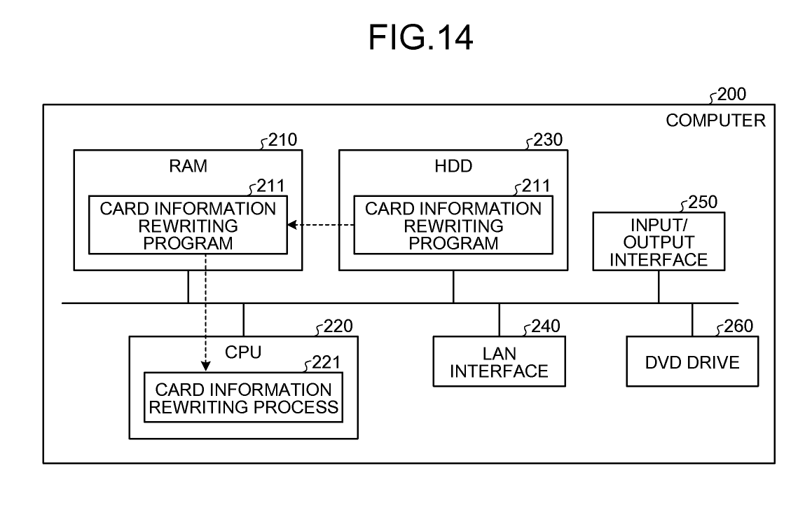

FIG. 14 is a functional block diagram of the configuration of the computer that executes a card information rewriting program according to the present embodiment. As depicted in FIG. 14, a computer 200 includes a RAM 210, a CPU 220, a hard disc drive (HDD) 230, a local area network (LAN) interface 240, an input/output interface 250, and a digital versatile disk (DVD) drive 260.

The RAM 210 stores therein a computer program, a result in the middle of executing the computer program, and the like, and the CPU 220 is a central processing unit that reads out and executes the computer program from the RAM 210.

The HDD 230 stores therein a computer program and data, and the LAN interface 240 is an interface for connecting the computer 200 to another computer via a LAN.

The input/output interface 250 is an interface for connecting an input device such as a mouse, and a keyboard, and a display device. The DVD drive 260 reads from, and writes in a DVD.

A card information rewriting program 211 executed in the computer 200 is stored in a DVD, and is installed in the computer 200 by being read out from the DVD by the DVD drive 260.

Alternatively, the card information rewriting program 211 is stored in a database of another computer system connected via the LAN interface 240 and the like, and is installed in the computer 200 by being read out from the database.

The installed card information rewriting program 211 is stored in the HDD 230, is read by the RAM 210, and is executed by the CPU 220 as a card information rewriting process 221.

Similarly, as regards the card information rewrite controlling apparatus, the configuration of the function explained in the embodiment explained above can be realized by software, and the computer program can be executed by a computer similar to that explained above.

All or some of the processing explained to be performed automatically in the present embodiments can be performed manually, or all or some of the processing explained to be performed manually can be performed automatically by a known method.

In addition, the processing procedure, the control procedure, the specific name, the information including various types of data and parameters described in the explanation above, and the figures can be changed optionally unless otherwise noted.

Configuring components of each device described are function-conceptual, and may not necessarily be configured as described physically. In other words, specific modes of dispersion/integration of each device are not limited to those depicted in the figures, and all or some of the modes may be dispersed or integrated functionally or physically in optional units according to various loads, usage conditions, or the like.

Furthermore, all or some of the processing functions performed by the devices can be realized by a CPU, and a computer program analyzed and executed by the CPU, or can be realized as hardware by wired logic.

According to the embodiment, personal information including at least personal identification information for identifying an individual is acquired; availability information indicating availability of facilities within a given area for the individual is acquired based on the acquired personal information; card layout information that is format information of a card, in which the availability information of an area into which the individual enters is recorded, is acquired; and format information of a card is rewritten based on the acquired card layout information. Therefore, personal authentication is possible at each area even when the card layout information of the card for personal authentication use is different for each area.

According to the embodiment, when the exit of an individual from an area is notified, the format information of the card is rewritten based on card layout information corresponding to an area to which the individual belongs. Therefore, time required at the time of entrance to an area to which the individual belongs can be shortened because when the individual returns to the area to which he/she belongs, he/she can use a facility within the area to which he/she belongs without having to rewrite the format information stored in the card.

According to the embodiment, the format information of the card is erased when the exit of the individual from the area is notified. Therefore, it is possible to prevent leakage of information recorded in the card when an individual loses a card while he/she is traveling, or he/she has the card stolen.

According to the embodiment, the availability information includes information about an amount of money that is payable within the area by the card. Therefore, when an individual visits another business institution on a business trip, he/she can use a dining hall, or a company store at the business institution.

According to the embodiment, the availability information includes information about a terminal that is available within the area. Therefore, when an individual visits another institution on a business trip, he/she can use a terminal installed at the business institution.

[Note 1] According to one embodiment, an apparatus for rewriting card information includes:

a personal information acquiring unit that acquires personal information including at least personal identification information for identifying an individual;

a card information acquiring unit that acquires availability information indicating availability of facilities within a given area for the individual based on the personal information acquired by the personal information acquiring unit, and card layout information that is format information of a card in which the availability information of an area into which the individual enters is recorded; and

a card information rewriting unit that rewrites format information of a card based on the card layout information acquired by the card information acquiring unit.

[Note 2] According to an embodiment, the apparatus according to Note 1, further comprising an exit notifying unit that notifies exit from the area, wherein

upon being notified of the exit by the exit notifying unit, the card information rewriting unit rewrites the format information of the card based on card layout information corresponding to an area to which the individual who is exiting belongs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustration of the superiority and inferiority of the invention. Although the embodiments of the present inventions have been described in detail, it should be understood that the various changes, substitutions, and alterations could be made hereto without departing from the spirit and scope of the invention.

1. A system for rewriting card information comprising:
a personal information acquiring unit that acquires personal identification information for identifying an individual;
a card layout information acquiring unit that acquires card layout information indicating a format of a card which records availability information indicating availability of facilities within an area corresponding to the personal information acquiring unit; and
a card information rewriting unit that rewrites a format of availability information recorded in a card of an individual identified by the personal identification information acquired by the personal information acquiring unit into the format of the availability information indicating availability of facilities within the area corresponding to the personal information acquiring unit, based on the card layout information acquired by the card layout information acquiring unit.

2. The system according to claim 1, further comprising an exit notifying unit that notifies exit from the area, wherein
upon being notified of the exit by the exit notifying unit, the card information rewriting unit rewrites a format of availability information recorded in a card of an individual who is exiting into a format of availability information indicating availability of facilities within an area to which the individual who is exiting belongs.

3. The system according to claim 1, further comprising an exit notifying unit that notifies exit from the area, wherein
upon being notified of the exit by the exit notifying unit, the card information rewriting unit erases a format of availability information recorded in a card of an individual who is exiting.

4. The system according to claim 1, wherein the availability information includes information about an amount of money that is payable within the area by the card.

5. The system according to claim 1, wherein the availability information includes information about a terminal that is available within the area.

6. The system according to claim 1, further comprising
an availability information storage unit that stores the personal identification information for identifying an individual and the availability information indicating availability of facilities in association with each other, and
an availability information acquiring unit that acquires availability information corresponding to the personal identification information acquired by the personal information acquiring unit from the availability information stored by the availability information storage unit, and wherein
the card information rewriting unit generates format information which sets a format of the availability information acquired by the availability information acquiring unit as the format of the availability information indicating availability of facilities within the area corresponding to the personal information acquiring unit based on the card layout information acquired by the card layout information acquiring unit, and writes the format information generated into the card of the individual identified by the personal identification information acquired by the personal information acquiring unit.

7. The system according to claim 1, further comprising
an intra-card availability information reading unit that reads out availability information indicating availability of facilities by the individual identified by the personal identification information, from a storage unit of the card of the individual identified by the personal identification information, and wherein
the card information rewriting unit generates format information which sets the availability information read out by the intra-card availability information reading unit as the format of the availability information indicating availability of facilities within the area corresponding to the personal information acquiring unit based on the card layout information acquired by the card layout information acquiring unit, and writes the format information generated into the card of the individual identified by the personal identification information acquired by the personal information acquiring unit.

8. A method for rewriting card information comprising:
firstly acquiring, by a personal information acquiring unit, personal identification information for identifying an individual;
secondly acquiring card layout information indicating a format of a card which records availability information indicating availability of facilities within an area corresponding to the personal information acquiring unit; and
rewriting a format of availability information recorded in a card of an individual identified by the personal identification information acquired in the firstly acquiring into the format of the availability information indicating availability of facilities within the area corresponding to the personal information acquiring unit, based on the card layout information acquired in the secondly acquiring.

9. The method according to claim 8, further comprising
notifying exit from the area, and wherein
when the exit from the area is notified, a format of availability information recorded in a card of an individual who is exiting is rewritten into a format of availability information indicating availability of facilities within an area to which the individual who is exiting belongs.

10. The method according to claim 8, further comprising
notifying exit from the area, and wherein
when the exit from the area is notified, a format of availability information recorded in a card of an individual who is exiting is erased.

11. The method according to claim 8, wherein the availability information includes information about an amount of money that is payable within the area by the card.

12. The method according to claim 8, further comprising
storing the personal identification information for identifying an individual and the availability information indicating availability of facilities in association with each other, and
thirdly acquiring availability information corresponding to the personal identification information acquired in the firstly acquiring from the availability information stored in the storing, and wherein
the rewriting includes generating format information which sets a format of the availability information acquired in the thirdly acquiring as the format of the availability information indicating availability of facilities within the area corresponding to the personal information acquiring unit based on the card layout information acquired in the secondly acquiring, and writing the format information generated into the card of the individual identified by the personal identification information acquired in the firstly acquiring.

13. The method according to claim 8, further comprising
reading out availability information indicating availability of facilities by the individual identified by the personal identification information, from a storage unit of the card of the individual identified by the personal identification information, and wherein
the rewriting includes generating format information which sets the availability information read out in the reading as the format of the availability information indicating availability of facilities within the area corresponding to the personal information acquiring unit based on the card layout information acquired in the secondly acquiring, and writing the format information generated into the card of the individual identified by the personal identification information acquired in the firstly acquiring.

14. A computer readable storage medium storing a card information rewriting program which makes a computer perform a card information rewriting method, the card information rewriting program makes the computer perform the method comprising:
firstly acquiring, by a personal information acquiring unit, personal identification information for identifying an individual;
secondly acquiring card layout information indicating a format of a card which records availability information indicating availability of facilities within an area corresponding to the personal information acquiring unit; and
rewriting a format of availability information recorded in a card of an individual identified by the personal identification information acquired in the firstly acquiring into the format of the availability information indicating availability of facilities within the area corresponding to the personal information acquiring unit, based on the card layout information acquired in the secondly acquiring.

15. The medium according to claim 14, wherein the method further comprising
notifying exit from the area, and wherein
when the exit from the area is notified, a format of availability information recorded in a card of an individual who is exiting is rewritten into a format of availability information indicating availability of facilities within an area to which the individual who is exiting belongs.

16. The medium according to claim 14, wherein the method further comprising
notifying exit from the area, and wherein
when the exit from the area is notified, a format of availability information recorded in a card of an individual who is exiting is erased.

17. The medium according to claim 14, wherein the availability information includes information about an amount of money that is payable within the area by the card.

18. The medium according to claim 14, wherein the method further comprising
storing the personal identification information for identifying an individual and the availability information indicating availability of facilities in association with each other, and
thirdly acquiring availability information corresponding to the personal identification information acquired in the firstly acquiring from the availability information stored in the storing, and wherein
the rewriting includes generating format information which sets a format of the availability information acquired in the thirdly acquiring as the format of the availability information indicating availability of facilities within the area corresponding to the personal information acquiring unit based on the card layout information acquired in the secondly acquiring, and writing the format information generated into the card of the individual identified by the personal identification information acquired in the firstly acquiring.

19. The medium according to claim 14, wherein the method further comprising
reading out availability information indicating availability of facilities by the individual identified by the personal identification information, from a storage unit of the card of the individual identified by the personal identification information, and wherein
the rewriting includes generating format information which sets the availability information read out in the reading as the format of the availability information indicating availability of facilities within the area corresponding to the personal information acquiring unit based on the card layout information acquired in the secondly acquiring, and writing the format information generated into the card of the individual identified by the personal identification information acquired in the firstly acquiring.
